(19) United States
(12) Patent Application Publication
(10) Pub. No.: US 2025/0135838 A1
(43) Pub. Date: May 1, 2025

(54) COMPRESSOR MONITORING SYSTEM AND METHOD

(71) Applicant: Transportation IP Holdings, LLC, Norwalk, CT (US)

(72) Inventors: Vinay Bavdekar, Erie, PA (US); Shankar Chandrasekaran, Erie, PA (US); Ananthalakshmi Thiruvannamalai Viswanathan, Erie, PA (US); Munishwar Ahuja, Bengaluru (IN)

(73) Assignee: Transportation IP Holdings, LLC, Norwalk, CT (US)

(21) Appl. No.: 18/925,634

(22) Filed: Oct. 24, 2024

Related U.S. Application Data
(60) Provisional application No. 63/593,314, filed on Oct. 26, 2023.

(51) Int. Cl. B60H 1/00; F04D 27/00

(52) U.S. Cl. CPC B60H 1/00978; F04D 27/001

(57) ABSTRACT

A monitoring system and method monitor one or more parameters of at least a first component of a compressed air system of a vehicle while a speed of a compressor motor of the compressed air system is modified over time. The one or more parameters are monitored based on signals generated by one or more sensors. The monitoring system and method determine a condition of at least the first component of the compressed air system based on an analysis of the one or more parameters that are monitored.

### CROSS-REFERENCE TO RELATED APPLICATION

This application claims benefit under 35 U.S.C. § 119(e) to U.S. Provisional Application No. 63/593,314, filed Oct. 26, 2024, entitled “COMPRESSOR MONITORING SYSTEM AND METHOD,” the entire disclosure of which is hereby incorporated by reference herein.

### BACKGROUND

### Technical Field

The subject matter described herein relates to monitoring and diagnosing the condition of vehicle motors, pumps, and other components associated with compressors.

### Discussion of Art

Some vehicle systems are powered by motors and/or pumps. Some vehicle systems use motors to power pumps to move fluid. For example, compressed air systems compress air that can be used by vehicle air brake systems, fuel cells, powering pneumatic tools, and/or the like. A compressed air system has a compressor motor that powers a pump to compress air. The compressed air system optionally includes a reservoir (e.g., tank) to contain the compressed air. Power to the compressor motor may be controlled by one or more switch devices. Components of vehicle compressed air systems are prone to experiencing failures and degraded operation prior to an anticipated end of life. For example, compressor motors may overheat due to degraded insulation and may also fail due to eccentric rotation of the rotor in the stator. The switch devices, such as contactors, that power the motor may fail due to excessive wear, oxide build-up on the contact surface, weakened springs, and/or the like.

It may be difficult to predict the end of life of one or more components of the compressed air system. Some known systems do not adequately monitor the condition or health of compressed air systems. Some known systems may be limited to tracking cyclic data, such as counting contactor cycles, and comparing the tracked cyclic data to a designated limit (e.g., cycle limit) that is associated with an expected end of life. Health determinations made based on tracked operations such as contactor cycles may not be accurate at predicting the end of life of a compressor because such health determinations are generic and do not account for specific characteristics and conditions of the actual components being monitored. As a result of such poor, non-individualized monitoring, compressor failures are common in the field. Compressor failures can result in delays (e.g., travel delays), an increased number of unscheduled maintenance events, increased part costs to due to part replacements and collateral damage to nearby parts, and/or the like. It may be desirable to have a system and method that differs from those that are currently available.

### BRIEF DESCRIPTION

In one embodiment, a method is provided that includes monitoring one or more parameters of at least a first component of a compressed air system of a vehicle while a speed of a compressor motor of the compressed air system is modified over time. The one or more parameters are monitored by one or more processors based on signals generated by one or more sensors. The method includes determining a condition of at least the first component of the compressed air system based on an analysis of the one or more parameters that are monitored.

In one embodiment, a monitoring system is provided that includes one or more sensors and a controller. The controller has one or more processors configured to receive signals generated by the one or more sensors. The controller is configured to use the signals to monitor one or more parameters of at least a first component of a compressed air system of a vehicle while a speed of a compressor motor of the compressed air system is modified over time. The controller is configured to determine a condition of at least the first component of the compressed air system based on an analysis of the one or more parameters that are monitored.

### BRIEF DESCRIPTION OF THE DRAWINGS

The subject matter may be understood from reading the following description of non-limiting embodiments, with reference to the attached drawings, wherein below:

FIG. 1 is a block diagram of a monitoring system and a vehicle according to an embodiment;

FIG. 2 is a swim lane diagram showing example operations of the monitoring system and a vehicle control system according to an embodiment; and

FIG. 3 is a flow chart of a method of monitoring a compressed air system according to an embodiment.

### DETAILED DESCRIPTION

Embodiments of the subject matter described herein relates to monitoring and diagnosing the condition of compressed air systems and components thereof. A monitoring system and method are described herein that may monitor one or more parameters of at least a first component of a compressed air system of a vehicle based on signals generated by one or more sensors. The parameter(s) can be analyzed to determine a condition of at least the first component. Optionally, the condition may indicate, or may be used to determine, a predicted remaining life of the first component. The predicted remaining life may refer to an amount of time, a number of operating cycles or operating events of the first component, or a percentage value indicating amount of life left relative to a full lifetime.

In one or more examples, the monitoring system can include a diagnostic kit that has one or more external sensors and a controller (e.g., a kit controller). The controller includes and/or is connected to one or more processors. The diagnostic kit may be non-permanently disposed onboard the vehicle that includes the compressed air system to be monitored. For example, an operator may carry the diagnostic kit onboard the vehicle and set up the one or more external sensors to monitor one or more components of the compressed air system. The one or more external sensors may be removably coupled to the compressed air system. For example, a current sensor (e.g., electric current sensor) may be clamped or otherwise electrically connected to a power cable, power terminal, or the like of the compressed air system to monitor electric current conducted to the compressed air system. The one or more processors of the diagnostic kit may receive and analyze the signals generated by the external sensors to monitor one or more parameters of at least a first component of the compressed air system. The one or more processors may determine the condition of at least the first based on an analysis of the one or more parameters that are monitored. The diagnostic kit can be removed from the vehicle after testing. For example, the diagnostic kit can be transferred to a second vehicle after the testing to perform diagnostic testing on a compressed air system onboard the second vehicle.

In another example, the monitoring system does not include the diagnostic kit. For example, the one or more processors and/or the one or more sensors may be permanently (or semi-permanently) installed onboard the vehicle. Optionally, the one or more processors may be part of the vehicle control system. The sensors may be semi-permanently installed on the vehicle by mounting the sensors onboard the vehicle in a way that enables removing the sensors, if desired, by dismounting the sensors and disconnecting a communication pathway between the sensors and the processors.

In an example, the one or more parameters of at least the first component of the compressed air system are monitored as the operations of a compressor motor of the compressed air system are varied. For example, the speed of the compressor motor may be modified over a length of time in which the monitoring system is monitoring the parameters of the first component. The changing motor speeds may include controlling the motor to transition between an idle speed and multiple different operational, or notch, speeds. The monitoring system may analyze how the monitored parameters change as the motor speeds vary to determine the condition of at least the first component. The changes in the compressor motor speeds may be predefined as settings in a test sequence.

The one or more processors may communicate with a vehicle control system onboard the vehicle via communication devices (e.g., communication circuitry). For example, the vehicle control system may provide information to the diagnostic kit about motor operations which allows the one or more processors to correlate the monitored parameters over time with the motor operations. Furthermore, the vehicle control system may communicate planned changes in motor speed before implementing the planned speed changes to provide advance warning for the diagnostic kit to prepare for monitoring one or more compressor components that are impacted by the motor speed change.

The condition information determined by the monitoring system and method described herein can be used in various beneficial ways. The active monitoring aspect may improve reliability of the compressed air system by reducing the risk of unexpected instances of decreased operation. In another example, the condition information can be used to determine when to perform preventative maintenance to repair or replace one or more compressor components before the compressor components fail, therefore avoiding or reducing delay, damage, and/or the like attributable to compressor failure. In another example, the monitoring system and method may provide recommendations during a trip or mission of the vehicle based on the condition. For example, in response to determining that a compressed air system has degraded state or health, the monitoring system may recommend one or more restrictions on the compressed air system operations and/or on operations of another vehicle system onboard the vehicle to compensate for the degraded compressed air system without canceling the trip.

Suitable vehicles may include locomotives, automobiles, trucks, buses, mining vehicles, agricultural vehicles, and the like. These vehicles may be grouped together so as to be controlled to function together. For example, the locomotive may be coupled with other locomotives or rail cars; and trucks may be organized into convoys. For a locomotive group, these may be mechanically coupled and also have compressed air systems that are fluidly coupled.

If a system, apparatus, assembly, device, etc. (e.g., a controller, control device, control unit, etc.) includes multiple processors, these processors may be located in the same housing or enclosure (e.g., in the same device) or may be distributed among or between two or more housings or enclosures (e.g., in different devices). The multiple processors in the same or different devices may each perform the same functions described herein, or the multiple processors in the same or different devices may share performance of the functions described herein. For example, different processors may perform different sets or groups of the functions described herein.

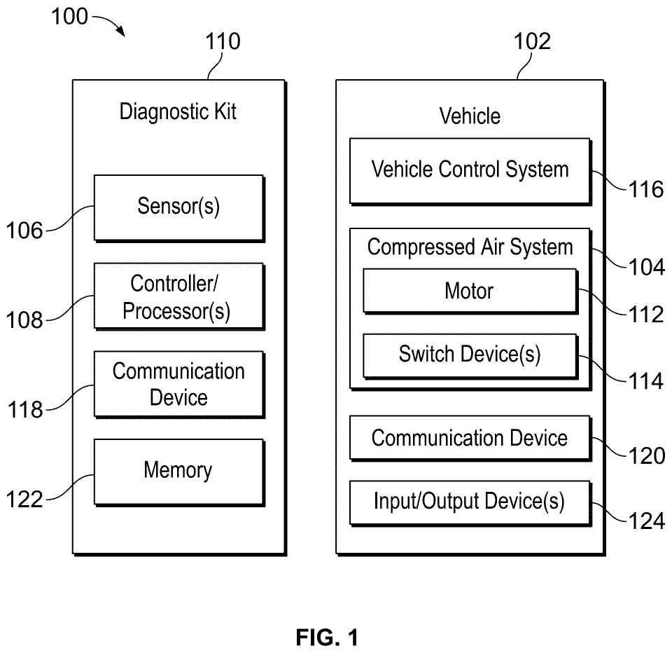

FIG. 1 is a block diagram of a monitoring system 100. The monitoring system can monitor a compressed air system 104 of a vehicle 102. The monitoring system includes one or more sensors 106 and a controller 108 that includes one or more processors. The compressed air system can include multiple components. The components may degrade and fail at unanticipated times prior to the expected end of life for a component. The sensors can monitor one or more parameters of the components. The sensors can generate sensor signals that are received and analyzed by the processors. The sensor signals may be affected by the state or condition of the components of the compressed air system. For example, an electrical characteristic of the sensor signal (e.g., voltage, current, phase, etc.) may vary based on the condition of a component that is monitored by the sensor, such as a temperature, resistance, rotation speed, vibration, proximity, and/or the like. The parameters can be monitored while a speed of a compressor motor 112 of the compressed air system changes. For example, the processors may monitor the component while the motor speed increases or decreases. Optionally, the processors may monitor the component while the motor speed is constant.

The processors may determine a condition of the component based on analysis of the monitored parameter. The condition may be used to plan preventative maintenance to avoid unexpected failures or a deteriorated condition. For example, the condition may be used to predict the remaining life of the component. This can allow for the component to be replaced prior to the end of the predicted remaining life while it is convenient to replace the component. The condition may be used to control and modify operations of the compressed air system and/or the vehicle. For example, upon determining that the component is degraded, the compressed air system may be operated to avoid use of, or limit forces exerted on, the component until the component can be inspected. In another example, the vehicle may be operated to employ another system to generate compressed air and/or to avoid or limit the generation of compressed air until inspection or maintenance on the compressed air system can be performed.

The compressed air system may include one or more switch devices 114 that control conduction of power to the motor. The switch devices may be actuated to selectively establish a conductive pathway from a power source to the motor and to selectively open the conductive pathway. The switch devices may be controlled by a vehicle control system 116. The switch devices may be contactors (e.g., relays) or other mechanical switches, solid state relays, and/or semiconductor electronic switches. In an example, one or more of the switch devices may be three-phase contactors that receive electrical power in three different phases of electric current. In an example, different groups of the switch devices can be used to control the motor at different settings. For example, a first group of the switch devices may control power to the motor while the motor operates at a first speed value or within a first range of speeds. Another group of the switch devices may control power to the motor while the motor operates at a different, second speed value or within a different, second range of speeds. In an example, the switch devices include a first switch device and a second switch device. The processors may monitor one or more parameters of the first and second switch devices to determine a condition of each of the switch devices. The switch devices may be the same as each other or differ from each other.

The sensors and the processors of the monitoring system can be part of a diagnostic kit 110. The diagnostic kit may be non-permanently disposed onboard the vehicle, may be carried by an operator, etc. The sensors of the monitoring system may include one or more electric current sensors, electric voltage sensors, temperature sensors, proximity sensors, acceleration and/or vibration sensors, and/or the like. The sensors may be removable sensors as the sensors may not be integral or permanently attached components of the vehicle. The sensors may be removably coupled to the compressed air system and/or the surrounding environment of the vehicle to monitor the compressed air system. For example, a current sensor (e.g., electric current sensor) may be clamped or otherwise electrically connected to a power cable, power terminal, or the like of the compressed air system to monitor electric current conducted to the motor of the compressed air system. In another example, a temperature sensor, proximity sensor, and/or accelerometer/vibration sensor may be removably affixed to the motor or a component connected with the motor to monitor one or more parameters of the motor. The processors may be communicatively connected to the sensors (and other components of the diagnostic kit) via wired and/or wireless communication pathways. For example, the processors may receive sensor signals generated by the sensors via a wired (e.g., electrically conductive) pathway. The processors may analyze the sensor signals to monitor the one or more parameters of the motor, the switch devices, and/or another component of the compressed air system.

The diagnostic kit may have a communication device 118 that enables the processors of the diagnostic kit to communicate with the vehicle control system of the vehicle during a monitoring operation. The communication device represents hardware circuitry that can communicate electrical signals via wireless communication pathways and/or wired conductive pathways. The communication device may include transceiving circuitry (e.g., a transceiver or separate transmitter and receiver), one or more antennas, and the like, for wireless communication.

The vehicle may include a communication device 120 (referred to herein as vehicle communication device) that enables the vehicle control system to communicate with the processors of the diagnostic kit. The vehicle communication device represents hardware circuitry that can communicate electrical signals via wireless communication pathways and/or wired conductive pathways. The communication device may include transceiving circuitry, one or more antennas, and the like, for wireless communication with the communication device of the diagnostic kit. Alternatively, a communication cable may be used to provide a wired conductive pathway between the communication devices of the diagnostic kit and the vehicle. The cable may be an ethernet cable, an optical cable, or the like.

The processors of the diagnostic kit may define or represent a portion of a kit controller. For example, the kit controller/system can represent hardware circuitry that includes or is connected with one or more processors. The processors can be microprocessors, integrated circuits, microcontrollers, field programmable gate arrays, etc. The processors may be connected with a tangible and non-transitory computer-readable storage medium (e.g., data storage device, computer memory, etc.) 122. The memory stores program instructions (e.g., software) that are executed by the processors to perform various operations described herein. For example, the processors may execute the program instructions stored in the memory to determine a condition of one or more components of the compressed air system based on monitored parameters. The processors may also execute the program instructions to perform one or more remedial or output tasks based on the condition as determined. For example, the processors may generate a recommendation message and/or control signals for controlling one or more systems onboard the vehicle based on the condition as determined to reduce a risk of compressed air system failure by restricting or modifying operation of the one or more onboard systems. The diagnostic kit may include a housing that collectively contains the processors, the memory, and the communication device. Optionally, one or more of the sensors may be communicatively connected to the housing via wired connections. The housing may be portable, such that an operator can easily carry the diagnostic kit onto and off from the vehicle.

The vehicle control system of the vehicle may represent hardware circuitry that includes and/or is connected with one or more processors (e.g., one or more microprocessors, integrated circuits, microcontrollers, field programmable gate arrays, etc.). The vehicle control system may include and/or is connected with a tangible and non-transitory computer-readable storage medium (e.g., data storage device, memory, etc.). The vehicle memory may store program instructions (e.g., software) that are executed by the vehicle control system (e.g., one or more processors thereof) to perform the operations of the vehicle control system that are described herein. For example, the vehicle control system may execute the program instructions stored in the vehicle memory to control the compressor motor during a test sequence and to communicate with the diagnostic kit.

The vehicle may include one or more input/output devices 124. The input/output devices may include a display device for presenting graphical information, such as graphical user interfaces (GUIs), images, video, text messages, and/or the like. The display device may be positioned for viewing by an operator of the vehicle. For example, the display device may be installed within a cab of the vehicle. The input/output devices may include one or more physical buttons, toggles, touchscreens, microphones, and/or the like for receiving user input commands. For example, an operator may use a touchscreen integrated with the display device for initiating a test sequence to determine the condition of one or more components of the compressed air system. Optionally, the diagnostic kit may include one or more input/output devices. An input device on the diagnostic kit may be used by an operator to command the start of the test sequence. An operator may manipulate the input device on the diagnostic kit to, for example, remotely change a vehicle configuration, to select a test to be run, and/or to pass a message to the vehicle control system.

The monitoring system described herein is not limited to being disposed on the diagnostic kit shown in FIG. 1. In another example, the processors and the sensors are not disposed on a discrete diagnostic kit. For example, the monitoring system may include one or more sensors that are permanently (or semi-permanently) affixed to the vehicle, meaning that the sensors are not intended to be removed from the vehicle and installed on another vehicle. The processors of the monitoring system may be processors of the vehicle control system or another controller disposed onboard the vehicle. In an example, the processors may be part of the vehicle control system (e.g., permanently secured on the vehicle), and the sensors are disposed on a discrete diagnostic kit. The processors may wirelessly communicate with the external diagnostic kit for the sensors of the kit to collect data for the processors to analyze.

The one or more components of the compressed air system that are monitored by the monitoring system may include the motor itself. Parameters associated with the motor that may be monitored include eccentricity, temperature, and/or the like. Eccentricity refers to misalignment between the rotor and the stator of the motor. For example, eccentricity may be characterized by an offset between an axis of rotation of the rotor and an axis of symmetry of the stator. Eccentricity can be used to determine condition of the motor because increased eccentricity over time indicates a degraded motor state or health. A degraded motor may increase eccentricity due to a constant increase in magnetic pull on one side. Eccentricity may be derived from measurements of spacing or gap between the rotor and the stator, motor vibration, and/or the like. For example, a proximity sensor may be installed in the motor to monitor the spacing between the rotor and the stator. A vibration sensor (e.g., an accelerometer) may be installed on the motor to monitor vibration of the motor during operation.

An electrical current signature generated by an electric current sensor may be used to automate the eccentricity detection analysis. For example, a Fast Fourier Transform (FFT) may be calculated to extract the sidebands introduced in current signature due to eccentricity in the induction motor. FFT may be performed on the sum of square of motor phase current (e.g., Ia²+Ib²+Ic²). For a machine with p pole pairs, the sidebands occur at frequency fs(1±1/p), where fs is the fundamental frequency of operation. The sum of squares of the components in a finite band around fs(1±1/p) is extracted and expressed as a fraction of the fundamental current. The fault measure extracted would have a spread based on the loading level. The nature of this spread may be extracted through machine learning on experimental data. A reverse function may then be used to estimate the level of eccentricity which is expressed as percentage of baseline air gap.

Another parameter of the motor that may be monitored is temperature. The motor temperature may be measured by a temperature sensor coupled to the motor. The temperature parameter may be used to detect turn to turn faults.

In an example, the processors of the monitoring system may analyze the parameters of the one or more compressor components that are monitored over time to determine a condition of the one or more components. For example, after the vehicle control system has finished performing the test sequence (e.g., completed a motor notch sweep), the processors may analyze the parameters that are monitored. The processors may access sensor data generated by the one or more sensors of the monitoring system during the test sequence.

In an example, the processors may determine the condition of one or more of the compressor components by comparing a value of a parameter of the respective component to a designated threshold value or a designated range. The designated threshold value and/or designated range may be stored in a memory device, such as the memory of the monitoring system. For example, if the value of the parameter is below the designated threshold value or within the designated range, the processors may determine the condition of the component as having a productive (e.g., healthy) state or condition. Alternatively, the processors may determine that the component is degraded if the parameter value as measured is at or above the designated threshold value or outside of the designated range. Optionally, the processors may determine that the component is productive and unimpaired (e.g., healthy) if the parameter value as measured is above the designated threshold value and may determine that the component is degraded if the parameter value is at or below the designated threshold value.

In an example, the processors may determine the condition of one or more of the compressor components based on a comparison to historical parameter data collected for the component. For example, the processors may record the data collected during each monitoring session (e.g., each test sequence) to a database. The data may be aggregated over time to determine a trend of the parameter over time. The processors may compare the values of the parameter collected during each new monitoring session to the historical trend data. The processors may interpret a significant deviation (e.g., step change) in the parameter values compared to the historical data as a signal that the component is degraded. Furthermore, the processors may calculate a slope of a trend line in the historical data. If the slope of the trend line is greater than (or less than) a threshold slope, the processors may flag the component as degraded. Furthermore, the trend line may be used by the processors to predict the remaining life of the component. For example, a monitored parameter may gradually increase over time as the component ages. The processors may use the most recent parameter values and the trend line to predict when the parameter values will reach a threshold value that is associated with failure and/or end of life.

In an example, the processors may monitor, as a parameter, material usage and replacement during operation of the compressed air system. The processors may track material usage over time and may record data about material usage in a database. In addition to material usage, the processors may track part replacement over time. The processors may analyze the material usage data and/or part replacement data in the database to determine a respective trend. The processors may use the trend to predict a remaining amount of life of a component before maintenance and/or replacement, to predict when to replenish a stock of material, and/or the like. The processors may use the information in the database to determine when to reset or initiate the cycle count. As such, the cycle of operation may be reset based on material usage. This information about the cycle count may be communicated to the vehicle control system.

In another example, the processors may determine the condition of one or more of the compressor components based on offsets between multiple parameter values. For example, at least some of the switch devices of the compressed air system may be three-phase contactor that receive electric current in each of three phases. The processors of the monitoring system may use at least one current sensor to monitor the electric current in each of the three phases received at the three-phase contactor. The processors may compare values of the current in the three phases to one another and determine an offset between the values. The offset refers to the difference between the current of the one phase and the current of another phase received at the three-phase contactor during a common time period (e.g., at the same time). A measured offset that is greater than a threshold offset value may indicate degradation or fault in the three-phase contactor or connected circuitry.

In another example of offset, the processors of the monitoring system may compare a measured value of a first parameter that is monitored to an expected value of the first parameter to determine an offset. The expected value may be based on historical performance of the relevant compressor component, a manufacturer rating, a message received from the vehicle control system, observed conditions, and/or the like. The one or more processors may determine the condition of the compressor component based on the offset. For example, a greater offset may indicate a greater extent of degradation.

The processors of the monitoring system may determine the condition based on different metrics, scales, references, and/or the like. For example, the processors may determine the condition for each compressor component monitored as a binary value, such as either indicating a productive (e.g., healthy) state or a degraded state. The processors may also determine a third option, which is whether the component has already failed and/or is non-functional. In an example, if the monitored parameter value is at or above the designated threshold value or within a designated range, then the processors determine the component is productive. On the other hand, the processors may determine the component to be degraded if the parameter value is below the designated threshold value or outside of the designated range. In another example, the condition may be a value along a scale, such as 1 to 10 or a percentage value. The processors, in providing the condition, may indicate a rate of degradation and/or a predicted remaining life of the compressor component. For example, the predicted remaining life may be based on an extent of offset between values of monitored parameters and/or a monitored parameter value and an expected parameter value. The level of offset may be tiered with multiple designated threshold values stored in the memory. Depending on which range a measured offset fall within, the processors may determine the predicted remaining life of the component. For example, the processors may provide the predicted remaining life in a 4-tiered arrangement, indicating 100% or full life remaining, 75% life remaining, 50% life remaining, and 25% life remaining.

The processors may determine a number of days, months, years, operational cycles, and/or the like to represent the remaining life of the component based on the determined condition of the component and an expected life span for the component. For example, if the determined condition is that the component is at 50% health, meaning 50% life remaining, then the processors may divide the expected operational life span of the component in half to estimate the predicted remaining life.

The rate of degradation may be based on the trend determined by recording the parameter data as monitored over time. The rate of degradation may be used to determine a specific day or time period in which the component should be replaced or repaired to avoid a compressed air system failure. For example, the processors may use the trend to determine when the monitored parameter of the component is predicted to reach a threshold value that is associated with failure or an elevated risk of failure due to the degradation of the component.

The processors may generate a notification message that includes the condition and/or additional information. The additional information may include the predicted remaining life, the rate of degradation, the predicted day or time period at which the component may fail, and/or the like. The notification message may be communicated to the vehicle control system for display on a display device onboard the vehicle. Optionally, the notification message may be communicated to a personal computing device (e.g., smartphone, tablet computer, smartwatch, or the like) of the operator.

In an example, in response to determining that one or more of the components of the compressed air system have a degraded condition or have failed, the processors may take one or more remedial actions to reduce the rate of degradation of the respective components, limit collateral damage, and avoid canceling a planned trip of the vehicle. The remedial actions may be stored as program instructions in the memory. The remedial action to take may be determined by the processors based on the specific component(s) determined to be degraded, the determined extent of degradation, and remedial options onboard the vehicle. The monitoring system may have several different failure modes. Some failure modes may be offsettable, which means the vehicle and/or compressed air system may still operate after determining the failure mode, albeit in a restricted operation. Other failure modes may be absolute, forcing the processors to immediately cease that specific component operation, the entire compressed air system operation, the vehicle operation, and/or the like.

In an example, in response to the processors determining that a first switch device has a degraded condition, the processors may implement a restricted mode. In the restricted mode, the processors may recommend controlling the compressor motor to operate at one or more speeds that do not require actuating (e.g., closing) the first switch device. The processors recommend avoiding the use of the degraded switch device, at least until a trip of the vehicle is completed or until the switch device can be examined in detail during a maintenance operation. The processors may provide such a recommendation in a message communicated to the vehicle control system via the established communication link. In another example, if the motor is degraded, a restricted mode may involve operating the motor only at designated low speeds (e.g., speeds below a designated threshold speed).

In another example, the processors of the monitoring system may recommend reducing the load on the compressed air system and/or enlisting another source of compressed air instead of the compressed air system. For example, the processors of the monitoring system may recommend operating the vehicle in a way that consumes less compressed air than if the degraded component(s) were not degraded. In another example, the processors may recommend utilizing a different source of compressed air onboard the vehicle other than the compressed air system. The vehicle may have an auxiliary or supplemental compressed air source onboard. The processors may recommend activating the auxiliary compressed air source, or, if already operating, increasing the load on the auxiliary compressed air source to compensate for the reduced or non-existent output by the compressed air system. Furthermore, the processors may automatically schedule maintenance and/or notify the operator whenever a degraded and/or failed compressor component is detected.

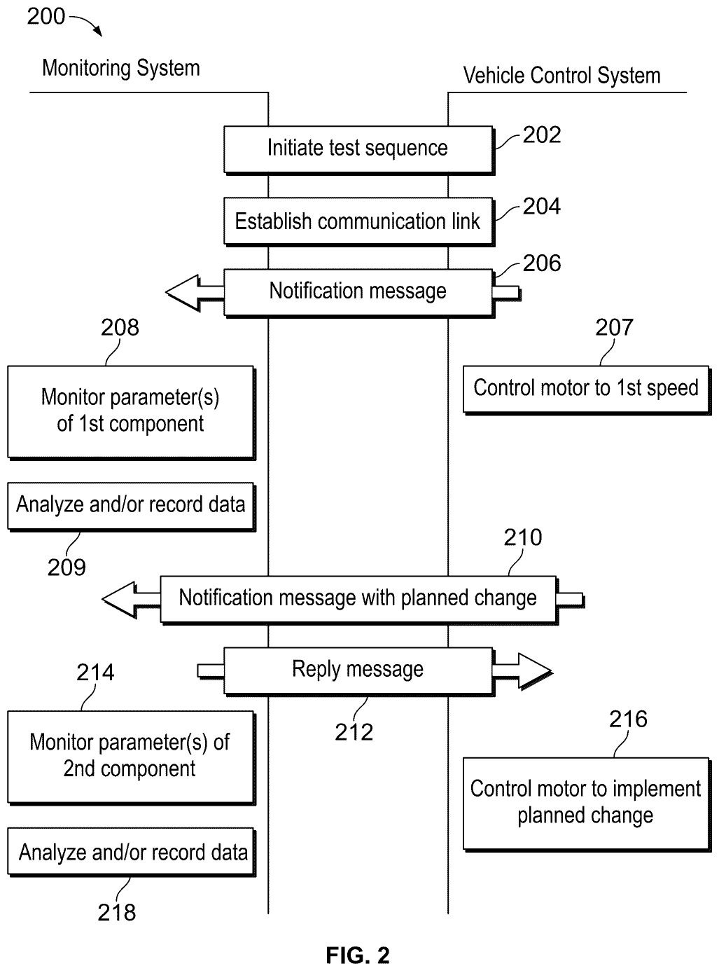

FIG. 2 is a swim lane diagram 200 showing example operations of the monitoring system and the vehicle control system according to an example. The monitoring system may be the monitoring system shown in FIG. 1. The vehicle control system may be the vehicle control system shown in FIG. 1. The swim lane diagram shows a series of events. At least some of the events may be performed by the processors of the monitoring system according to program instructions stored in the memory.

At step 202, a test sequence is initiated. The test sequence can include settings for changing the speed of the compressor motor over time. In an example, the test sequence may be initiated after the diagnostic kit is set up such that the removable sensors are coupled to the compressed air system. The test sequence may be initiated based on receiving a user input command to start the test. The user input command may be provided by an operator using the input/output device of the vehicle. Alternatively, an operator may use an input/output device of the diagnostic kit to generate the user input command. Upon receiving the user input command, the processors of the diagnostic kit may communicate a test initiation message to the vehicle control system. An operator may provide the user input command to initiate the test sequences when the operator desires running the monitoring system to determine the condition of one or more components of the compressed air system. During the test sequence, the vehicle control system may control the compressor motor to perform a notch sweep. The notch sweep can include controlling the motor to alternate between different speeds or power levels. The different speeds or power levels can be associated with different notch settings.

In an example, the test sequence may be an outbound test that is performed to approve the vehicle for regular service. Regular service can refer to the vehicle being available and permitted to perform planned trips, such as trips to transport cargo and/or passengers. A vehicle that is approved for regular service may be classified as being part of an active fleet of vehicles. For example, the vehicle may have been removed from regular service to receive maintenance, whether scheduled or unscheduled. Before the vehicle may be cleared to resume regular operations (e.g., perform trips), the outbound test may be performed to determine whether the compressed air system and related systems of the vehicle are operating as expected. The vehicle may not be permitted to return to regular service until it passes the outbound test. Optionally, the outbound test may be performed on new vehicles as well, to ensure that the compressed air system is operating as expected prior to permitting the new vehicles to begin regular service. In an example, the outbound test may be an automated self-load outbound test (ASLOT), in which the vehicle control system checks various systems to determine whether the vehicle (e.g., locomotive) can successfully attain a self-load mode.

At step 204, a communication link is established between the diagnostic kit and the vehicle control system. For example, the vehicle control system may communicate a link request message, via the communication device of the vehicle, to the diagnostic kit. The communication device of the diagnostic kit may receive the link request message and forward details to the processors for analysis and response. The processors of the diagnostic kit may generate a link reply message that is communicated by the communication device of the diagnostic kit to the communication device of the vehicle. In general, communications between the monitoring system (e.g., the diagnostic kit) and the vehicle (e.g., the vehicle control system) described with reference to FIG. 2 may be facilitated via the respective communication devices unless otherwise specified. The communication link may be established upon receipt of the link reply message at the vehicle control system.

At step 206, the processors of the diagnostic kit receive a notification message from the vehicle control system. The notification message may indicate the speed of the compressor motor. For example, the notification message may provide a current speed of the motor, a notch setting of the motor, or a characteristic of the motor that can be used by the processors to derive the speed of the motor. This characteristic can be a rotational frequency of the rotor of the motor and/or an electrical characteristic of power received by the motor. Alternatively, instead of indicating the speed of the motor, the notification message may indicate which component or components are to be monitored by the monitoring system during the test.

At step 207, the motor can be controlled to operate at a first speed (e.g., a first rotational speed). The first speed may be according to a setting defined by the test sequence.

At step 208, at least a first parameter of a first component of the compressed air system is monitored during a first time period. The first time period may correspond to the speed of the motor being a first value (e.g., first speed value) or within a first range (e.g., first speed range). The first parameter of the first component may be monitored by collecting sensor signals generated by the sensor(s) during the first time period. The processors may monitor the first parameter of the first component for at least a threshold amount of time. The sensor may generate an electrical current signature, and the processors may analyze the electrical current signature to determine the first parameter. The electrical current signature may be a value of the electric current generated by the sensor over a period of time. The first parameter may be electric current conducted to the first component. In another example, the first parameter may be derived based on the electric current conducted to the first component. As an example, the first parameter may be a charge parameter that is calculated as current times time and/or current squared times time (e.g., I*t and/or I²*t).

At step 209, the data corresponding to the first component may be recorded or analyzed. In an example, the processors may analyze the data immediately upon receipt. Alternatively, the processors may store the data at least temporarily in the memory device onboard the diagnostic kit for future analysis. For example, the processors may analyze the data after the test sequence is completed. After the processors of the diagnostic system have received sufficient data for monitoring the first parameter of the first component, the processors may generate a message indicating approval for the vehicle control system to advance to the next portion of the test sequence.

At step 210, the vehicle control system may generate a second notification message for communication to the diagnostic kit. The second notification message may indicate a planned change in the speed of the compressor motor prior to changing the motor speed. The new speed value, notch setting, or the like, of the planned change may be part of the test sequence. For example, settings of the test sequence may be stored in the memory and performed in a preset order. The second notification message may indicate a time at which the planned change is anticipated to occur. For example, the second notification message may provide that the motor speed will increase to a designated value or notch setting after a designated period of time has elapsed, such as 30 seconds. Receiving the second notification message with the planned change allows the processors of the diagnostic system to prepare for the change. For example, the processors of the diagnostic system can monitor one or more components of the compressed air system that are affected by the change in motor speed during the transition period itself, rather than simply reacting to the change after the transition period has started.

In an example, after receiving the second notification message, the processors of the diagnostic kit may generate a reply message at step 212. The reply message may indicate approval for the vehicle control system to implement the planned change in the speed of the compressor motor. For example, the reply message may indicate that the processors have received sufficient data from monitoring the first parameter of the first component for analysis, and the test sequence can advance to the next stage. The reply message is communicated to the vehicle control system. The vehicle control system optionally may not proceed with the next stage of the test sequence until receiving the reply message. The reply message at step 212 is optional. For example, the vehicle control system may advance to the next stage after a designated amount of time following the communication of the second notification message, regardless of whether the reply message is received from the diagnostic kit.

At step 214, the processors of the diagnostic kit may switch from monitoring the first parameter of the first component to monitoring one or more parameters of a second component of the compressed air system. The processors may select the second component to monitor based on the planned change in the speed of the compressor motor as indicated in the second notification message. For example, the transition between the first speed of the motor to a planned second speed of the motor may be caused by, or may cause a change in, the second component. The processors of the diagnostic kit may begin monitoring the one or more parameters of the second component prior to the planned change in the motor speed to capture the transition period.

At step 216, the vehicle control system may modify the motor speed to implement the planned change. For example, the planned change may be to increase the notch setting to cause the motor to achieve a second motor speed value or range. The second motor speed is different from the first motor speed that is present while the first parameter of the first component is being monitored at step 208. The second motor speed value or range may impact or require operation of the second component. Because the processors have already switched to monitoring the second component, the processors are able to determine one or more parameters of the second component during the transition from the first motor speed to the second motor speed, as well as after the transition.

The processors of the diagnostic system at step 218 may analyze the data corresponding to the second component immediately upon receipt or may record and/or store the data in the memory device for analysis at a later time, such as after the entire test sequence is completed. After the processors of the diagnostic system have received sufficient data for monitoring the one or more parameters of the second component, the processors may generate a message indicating approval for the vehicle control system to advance to the next portion of the test sequence and/or wait for receipt of a third notification message that includes a second planned change to the motor speed. For example, the process may return to step 210, and the steps 210, 212, 214, 216, and 218 may repeat for each of multiple different parameters and/or different components of the compressed air system to be monitored, until the test sequence is completed.

Optionally, instead of or in addition to switching components that are monitored, the processors at step 214 may switch from monitoring the first parameter of the first component to monitoring a second parameter of the same first component. The processors may select whether to monitor a second parameter of the first component and/or monitor a parameter of a second component of the compressed air system at step 214 based on the planned change and/or the notification message received from the vehicle control system. Optionally, depending on the planned change and/or the notification message, the processors may continue monitoring the first parameter of the first component even after starting to monitor the second parameter of the first component and/or a parameter of the second component.

As described above, during the test sequence the processors of the monitoring system may remain in frequent communication with the vehicle control system. The vehicle control system controls the operations of the compressed air system and changes the motor speed over time. The vehicle control system informs the processors of the monitoring system how it controls the compressed air system and may provide advance notice of planned changes to the motor speed. The processors of the monitoring system use the information received from the vehicle control system about the compressed air system operations (e.g., motor speeds) to monitor data for one or more components of the compressed air system. For example, the processors may monitor components during transition periods as the motor speed changes from one set speed to another set speed. The processors may analyze the data collected to determine a condition of one or more components of the compressed air system.

In an example, the vehicle control system controls the compressor motor to be in an unloaded state during the test sequence. In the unloaded state, the compressed air system does not generate compressed air to fill a reservoir (e.g., the compressed air system does not compress air). For example, the compressor motor may be powered to operate (e.g., spin) as normal, but no air is compressed based on the motor operation. Controlling the motor to be in the unloaded state for the test sequence may beneficially reduce interference and/or noise in the sensor signals that are received and analyzed by the processors of the monitoring system. In another example, the vehicle control system may run the test sequence with the compressor motor in the loaded state, meaning that the compressed air system generates compressed air. For example, the vehicle control system may be able to run the test sequence in each of the loaded and unloaded states.

The processors of the monitoring system may repeat the test sequence as desired or required. For example, if the test is not able to be completed due to interruption, error, or the like, then the processors may re-run the test. The processors may also re-run the test to compare and contrast the monitored parameter data collected during the different tests and/or derive an average for the monitored parameter data based on the plural tests. Deriving the average may reduce the significance of outlier data points.

In an example of the workflow described in FIG. 2, the first component may be a first switch device of the switch devices of the compressed air system, and the second component may be a second switch device of the switch devices. The processors of the diagnostic system at step 208 may monitor a parameter of the first switch device, and the processors at step 214 may monitor a parameter of the second switch device. Optionally, the monitoring system may concurrently monitor one or more parameters of a second switch device and a third switch device at step 214. Although the following example describes only a second switch device, the following description can apply to monitoring both a second and a third switch device.

The switch devices could be a source of compressor failure, so the monitoring system may monitor the switch devices to detect signs of degradation. The switch devices are selectively actuated to control the power supplied to the motor. For example, the first switch device may be actuated by the vehicle control system to power the motor to achieve a first range of motor speeds, and the second switch device (and optionally third switch device) may be actuated by the vehicle control system to power the motor at a second range of motor speeds. Stated differently, to achieve different motor speeds, the vehicle control system may actuate or close different switch devices or combinations of switch devices to supply power to the motor. For example, the first switch device may be actuated to power the motor at speeds below a threshold speed. As an example, the threshold speed may be 580 RPM. The vehicle control system may open the first switch device and actuate (e.g., close) the second switch device to achieve speeds above the threshold speed. Optionally, the compressed air system may have more than one threshold speed. For example, at least a fourth switch device may be actuated to achieve motor speeds above a second threshold speed.

At step 206, the notification message received from the vehicle control system may indicate that the motor is operating at, or is going to be operated at, a speed or range of speeds that require the first switch device to be actuated while the second switch device is not actuated. For example, the notification message may explicitly or implicitly indicate that the first switch device will be actuated during a first time period, which allows the processors of the diagnostic kit to prepare to monitor the first switch device. The first switch device may provide a conductive path to supply power to the motor during a first time period, and the second switch does not supply any power to the motor during the first time period.

The parameters of the first and second switch devices that are monitored by the processors (using the sensors) may be actuation parameters which relate to measured operation of the switch devices. The actuation parameters may include a time-to-close, time-to-open, extend of chatter, contact resistance, and/or the like. During the first time period, the processors of the diagnostic kit monitor one or more actuation parameters of the first switch device. For example, the processors may monitor the time-to-close of the first switch device, the extent of chatter, and/or the contact resistance of the first switch device. The processors may use sensor signals generated by a current sensor to monitor one or more of these actuation parameters. For example, an electrical current signature generated by the current sensor over time may indicate a first time that the first switch device achieves the closed, conducting position. The processors may compare that first time to a second time at which the vehicle control system transmitted a control signal to the first switch device to actuate. The delay from the second time to the first time may indicate the time-to-close. As mechanical switch devices age, the time-to-close may gradually increase. The increase may be due to worn springs, increased electrical resistance, and/or the like.

The extent of chatter may be a measure of how cleanly the first switch device movable contact of the first switch device transitions from the open to closed states. For example, a degraded switch device may experience chatter as the movable contact essentially bounces into and out of physical contact with the stationary contact(s) before settling into the closed, conductive state. The extent of chatter may be monitored in the electrical current signature generated by the current sensor. For example, the monitored current may have several spikes in quick succession when the first switch device is actuated. The amplitude, number, and/or total duration of the spikes may indicate the extent of chatter. For example, a degraded switch device may experience larger spikes, more spikes, and/or a longer total time at which the spikes occurred than a healthier switch device.

The electrical resistance may refer to electrical resistance on the contacts of the switch device. The electrical resistance may increase over time due to oxide layers forming on the contact surfaces. The processors may perform an impedance analysis to determine the extent of oxidation (e.g., electrical resistance). For example, the processors may monitor a temperature of the first switch device over time across multiple different test sequences. Temperature values may be generated by a temperature sensor of the diagnostic kit. The temperature values may be stored in a database as historical data. The processors may compare a most recent temperature value and/or multiple recent temperature values to earlier temperature values of the same switch device recorded during earlier test sequences to determine if the temperature has increased relative to the earlier test sequences. The increase in temperature may be caused by increased electrical contact resistance at the contact surfaces.

Optionally, the processors may monitor multiple actuation parameters of the first switch device during the first time period. For example, the processors may monitor both the time-to-close and the extent of chatter.

Charge may be another parameter of the switch devices that is monitored by the monitoring system. The charge may be used by the processors in a charge cycle analysis to determine the condition of the switch device and optionally the remaining predicted life of the switch device. The processors may determine the charge parameter based on the current sensor measurements. For example, the charge parameter may be calculated as current times time and current squared times time (e.g., I*t and I²*t). The charge cycle analysis may include receiving cycle data of the switch device. The cycle data may be received from the vehicle control system. The cycle data refers to the number of actuation cycles performed by the switch device over time. The processors of the monitoring system may determine the condition of the switch device based on the charge parameter and the cycle data.

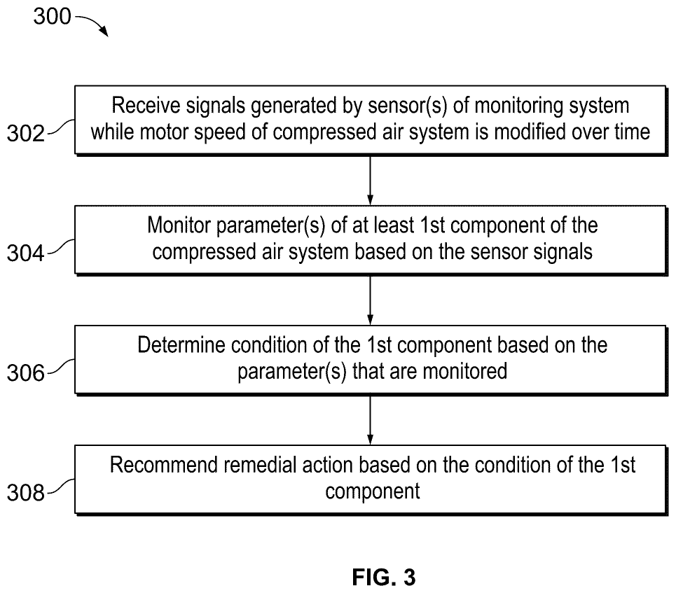

FIG. 3 is a flow chart 300 of an example method of monitoring a compressed air system. The method may be performed in full, or in part, by the processors (e.g., one or more processors) of the monitoring system shown in FIG. 1. Optionally, the method in other examples may include addition steps not shown, may have a different arrangement of the steps shown in FIG. 3, and/or may omit one or more of the steps shown in FIG. 3.

At step 302, signals generated by one or more sensors of a monitoring system are received by the processors. The signals are generated by the sensors while a compressor motor speed of a compressed air system is modified over time. The sensors may be removable sensors of a diagnostic kit. The sensors may include one or more current sensors, voltage sensors, proximity sensors, temperature sensors, accelerometers, and/or the like. Optionally, the processors may be part of the diagnostic kit. The method may include removably coupling the sensors to the compressed air system.

At step 304, the processors may analyze the received sensor signals to monitor one or more parameters of at least a first component of the compressed air system as the motor speed is varied over time.

At step 306, the processors may determine the condition of the first component based on an analysis of the one or more parameters that are monitored. The processors may determine, as part of the condition or based on the condition, a predicted remaining life span of the first component.

At step 308, the processors may recommend a remedial action that involves controlling operation of the first parameter based on the condition of the first component. The processors may provide the recommendation in a message that is communicated to the vehicle control system and/or to a computer device of an operator of the vehicle. The recommendation may suggest operating the vehicle, the compressed air system, and/or just the first component itself in a restricted mode. Or the recommendation may suggest ceasing operation of the first component, the compressed air system, and/or the entire vehicle until the first component can be addressed during a maintenance event.

Optionally, the method may include establishing a communication link between the diagnostic kit and a vehicle control system disposed onboard the vehicle. The method may include receiving, at the diagnostic kit, a notification message from the vehicle control system. The notification message may indicate a status of the speed of the compressor motor. The notification message may indicate a planned change in the speed of the compressor motor to notify the diagnostic kit prior to implementing the planned change in the speed of the compressor motor. The processors may switch from monitoring the one or more parameters of the first component to monitoring one or more parameters of a second component of the compressed air system in response to receiving the notification message. The second component may be selected for monitoring based on the planned change in the speed of the compressor motor. The processors may subsequently communicate a reply message from the diagnostic kit to the vehicle control system. The reply message may indicate approval for the vehicle control system to implement the planned change in the speed of the compressor motor.

The method may include initiating a test sequence. The test sequence may include settings for changing the speed of the compressor motor over time. The test sequence may be an outbound test that is performed to approve the vehicle for regular service. Optionally, the processors may monitor the one or more parameters comprises monitoring the one or more parameters while the compressor motor is in an unloaded state to reduce interference (e.g., noise) in the sensor signals.

The processors may monitor a first parameter of the first component of the compressed air system while the speed of the compressor motor is a first speed value or a first speed range, and may monitor (i) a second parameter of the first component and/or (ii) the first parameter of a second component of the compressed air system while the speed of the compressor motor is a second speed value or a second speed range.

Optionally, the compressed air system comprises at least a first switch device and a second switch device that control power to the compressor motor. The processors may monitor one or more actuation parameters of the first switch device and the second switch device. The one or more actuation parameters may include time-to-close, time-to-open, extent of chatter, and/or contact resistance. The processors may monitor the one or more actuation parameters of the first switch device during a first time period in which the first switch device is actuated and may monitor the one or more actuation parameters of the second switch device during a second time period in which the second switch device is actuated. The monitoring of the one or more actuation parameters of the second switch device may be responsive to receiving a notification message from a vehicle control system disposed onboard the vehicle prior to the second time period. The notification message may indicate that the second switch device will be actuated during the second time period.

The one or more sensors may include at least one current sensor. The processors may analyze one or more electrical current signatures generated by the at least one current sensor to determine values of the one or more parameters that are monitored. Optionally, the processors may determine a charge parameter of a switch device of the compressed air system. The processors may receive cycle data of the switch device and determine a predicted remaining life of the switch device based on both the charge parameter and the cycle data.

In response to the processors determining that the first switch device is degraded, the processors may recommend controlling the compressor motor to operate at one or more speeds that do not require closing the first switch device. Another remedial option in response to the processors determining that the first switch device is degraded is for the processors to recommend at least one of (i) operating the vehicle to consume less compressed air than if the first component was not in the degraded state or (ii) utilizing a different source of compressed air onboard the vehicle other than the compressed air system.

The processors may store values of at least a first parameter of the one or more parameters over time as historical data. The processors may analyze the historical data to determine a trend in the first parameter and determine the condition of the first component based on the trend. Optionally, the first component of the compressed air system may be a three-phase contactor. The processors may monitor electric current in each of three phases received at the three-phase contactor, compare values of the electric current in the three phases to one another, and determine an offset between the values. In another example, the processors may compare a measured value of a first parameter of the one or more parameters that are monitored to an expected value of the first parameter to determine an offset. The processors may determine the condition of the first component based on the offset. The processors may determine the predicted remaining life of the first component based on the offset.

In an embodiment, a method includes monitoring one or more parameters of at least a first component of a compressed air system of a vehicle while a speed of a compressor motor of the compressed air system is modified over time. The one or more parameters may be monitored based on signals generated by one or more sensors. The method may include determining a condition of at least the first component of the compressed air system based on an analysis of the one or more parameters that are monitored.

The method may include establishing a communication link between a diagnostic kit and a vehicle control system disposed onboard the vehicle, and receiving, at the diagnostic kit, a notification message from the vehicle control system. The notification message may indicate a status of the speed of the compressor motor. The method may include notifying the diagnostic kit prior to implementing a planned change in the speed of the compressor motor. The notification message may indicate a planned change in the speed of the compressor motor. The method may include switching from monitoring the one or more parameters of the first component to monitoring one or more parameters of a second component of the compressed air system in response to receiving the notification message. The second component may be selected for monitoring based on the planned change in the speed of the compressor motor. The method may include communicating a reply message from the diagnostic kit to the vehicle control system. The reply message may indicate approval for the vehicle control system to implement the planned change in the speed of the compressor motor.

The method may include initiating a test sequence that includes changing the speed of the compressor motor over time. The test sequence may be an outbound test that is performed to approve the vehicle for regular service. The method may include approving the vehicle for regular service based at least in part on the condition of the first component as determined.

The method may include monitoring the one or more parameters while the compressor motor is in an unloaded state. Optionally, monitoring the one or more parameters may include monitoring a first parameter of the first component of the compressed air system while the speed of the compressor motor is a first speed value or within a first speed range, and monitoring at least one of (i) a second parameter of the first component or (ii) the first parameter of a second component of the compressed air system while the speed of the compressor motor is a second speed value or within a second speed range.

The one or more parameters may be monitored by monitoring one or more actuation parameters of a first switch device and a second switch device that each controls power to the compressor motor. The one or more actuation parameters may include one or more of time-to-close, time-to-open, extent of chatter, or contact resistance. Monitoring the one or more actuation parameters may include monitoring the one or more actuation parameters of the first switch device during a first time period in which the first switch device is actuated, and monitoring the one or more actuation parameters of the second switch device during a second time period in which the second switch device is actuated. The monitoring of the one or more actuation parameters of the second switch device may be responsive to receiving a notification message from a vehicle control system disposed onboard the vehicle prior to the second time period. The notification message may indicate that the second switch device will be actuated during the second time period.

The one or more sensors may include at least one current sensor. The method may include analyzing one or more electrical current signatures generated by the at least one current sensor to determine values of the one or more parameters that are monitored. The method may include determining a predicted remaining life of the first component of the compressed air system based on the condition that is determined. Monitoring the one or more parameters may include determining a charge parameter of a switch device of the compressed air system. The method may include receiving cycle data of the switch device, and determining a predicted remaining life of the switch device based on both the charge parameter and the cycle data.

In response to the condition of a first switch device of the compressed air system indicating that the first switch device is in a degraded state, the method may include controlling the compressor motor to operate at one or more speeds that do not require closing the first switch device. Optionally, in response to the condition of the first component of the compressed air system indicating that the first component is in a degraded state, the method may include at least one of (i) operating the vehicle to consume less compressed air than if the first component was not in the degraded state or (ii) utilizing a different source of compressed air onboard the vehicle other than the compressed air system.

The method may include storing values of at least a first parameter of the one or more parameters over time as historical data, analyzing the historical data to determine a trend in the first parameter, and determining the condition of the first component based on the trend. Optionally, the first component of the compressed air system is a three-phase contactor, and monitoring the one or more parameters may include monitoring electric current in each of three phases received at the three-phase contactor. The method may include comparing values of the electric current in the three phases to one another and determining an offset between the values. The method may include comparing a measured value of a first parameter of the one or more parameters that are monitored to an expected value of the first parameter to determine an offset, and determining the condition of the first component based on the offset. The method may include determining a predicted remaining life of the first component based on the offset. Optionally, the first component of the compressed air system is the compressor motor, and monitoring the one or more parameters of the first component may include determining an eccentricity parameter of the compressor motor.

In an embodiment, a monitoring system includes one or more sensors and a controller having one or more processors that are configured to receive signals generated by the one or more sensors. The controller may use the signals to monitor one or more parameters of at least a first component of a compressed air system of a vehicle while a speed of a compressor motor of the compressed air system is modified over time. The controller may determine a condition of at least the first component of the compressed air system based on an analysis of the one or more parameters that are monitored.

The one or more sensors may be one or more removable sensors of a diagnostic kit that are removably coupled to the compressed air system. The diagnostic kit may include the controller that monitors the one or more parameters. The diagnostic kit may include a communication device. The communication device may establish a communication link between the diagnostic kit and a vehicle control system disposed onboard the vehicle. The communication device may receive a notification message from the vehicle control system. The notification message may indicate a status of the speed of the compressor motor. Optionally, the notification message may also indicate a planned change in the speed of the compressor motor to notify the diagnostic kit prior to implementing the planned change in the speed of the compressor motor. The controller may switch from monitoring the one or more parameters of the first component to monitoring one or more parameters of a second component of the compressed air system in response to receiving the notification message. The second component may be selected for monitoring based on the planned change in the speed of the compressor motor. The controller may generate a reply message to be communicated by the communication device to the vehicle control system. The reply message may indicate approval for the vehicle control system to implement the planned change in the speed of the compressor motor.

The controller may initiate a test sequence that includes settings for changing the speed of the compressor motor over time. The test sequence may be an outbound test, and the controller may initiate the outbound test to approve the vehicle for regular service. The controller may monitor the one or more parameters and determine the condition while the compressor motor is in an unloaded state. The controller may monitor a first parameter of the first component of the compressed air system while the speed of the compressor motor is a first speed value or a first speed range, and may monitor at least one of (i) a second parameter of the first component or (ii) the first parameter of a second component of the compressed air system while the speed of the compressor motor is a second speed value or a second speed range. Optionally, the first component is the compressor motor, and the controller may determine an eccentricity parameter of the compressor motor as one of the one or more parameters that are monitored.

The compressed air system may include at least a first switch device and a second switch device that control power to the compressor motor. The one or more parameters monitored by the controller may be one or more actuation parameters of the first switch device and the second switch device. The one or more actuation parameters may include one or more of time-to-close, time-to-open, extent of chatter, or contact resistance. The controller may monitor the one or more actuation parameters of the first switch device during a first time period in which the first switch device is actuated and monitor the one or more actuation parameters of the second switch device during a second time period in which the second switch device is actuated. The controller may monitor the one or more actuation parameters of the second switch device responsive to receiving a notification message from a vehicle control system disposed onboard the vehicle prior to the second time period. The notification message may indicate that the second switch device will be actuated during the second time period.

The one or more sensors may include at least one current sensor. The controller may analyze one or more electrical current signatures generated by the at least one current sensor to determine values of the one or more parameters that are monitored. The controller may determine a predicted remaining life of the first component of the compressed air system based on the condition that is determined. The controller may determine a charge parameter of a switch device of the compressed air system as one of the one or more parameters that are monitored. The controller may receive cycle data of the switch device and determine a predicted remaining life of the switch device based on both the charge parameter and the cycle data.

The controller may control the compressor motor to operate at one or more speeds that do not require closing a first switch device of the compressed air system in response to determining that the condition of the first switch device is a degraded state. The controller may generate a recommendation message to a vehicle control system of the vehicle in response to determining that the condition of the first component is a degraded state. The controller may generate the recommendation message to recommend that the vehicle control system at least one of (i) operate the vehicle to consume less compressed air than if the first component was not in the degraded state or (ii) utilize a different source of compressed air onboard the vehicle other than the compressed air system.

The controller may store values of at least a first parameter of the one or more parameters over time as historical data. The controller may analyze the historical data to determine a trend in the first parameter, and may determine the condition of the first component based on the trend. Optionally, the first component of the compressed air system is a three-phase contactor, and the controller may monitor the one or more parameters by monitoring electric current in each of three phases received at the three-phase contactor. The controller may compare values of the electric current in the three phases to one another and determine an offset between the values. The controller may compare a measured value of a first parameter of the one or more parameters that are monitored to an expected value of the first parameter to determine an offset. The controller may determine the condition of the first component based on the offset. The controller may determine a predicted remaining life of the first component based on the offset.

In one embodiment, the control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. Copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., the sensor signals generated by the sensors monitoring the one or more components of the compressed air system), use a model that associates signal data with different conditions or states of the components, and then provide an output (e.g., the determined condition of at least a first component of the compressed air system). The controller may receive additional input of the change in motor speed and/or other operational changes from the vehicle control system, a change in which component is being monitored by the sensor signals received, or a change in the parameter that is being sensed or measured by the sensor signals. Based on this additional input, the controller can change the model, such as by changing which sensor signals that controller analyzes and how the controller analyzes the sensor signal to determine a condition of at least one of the components of the compressed air system. The controller can then use the changed or updated model again to determine the condition of the component, receive feedback on the selected model, and/or determine a remedial action in response to the condition of the component (e.g., to reduce the risk of part failure, aborted trip, etc.). The controller may repeatedly improve or change the model using artificial intelligence or machine learning.

As used herein, the “one or more processors” may individually or collectively, as a group, perform these operations. For example, the “one or more” processors can indicate that each processor performs each of these operations, or that each processor performs at least one, but not all, of these operations.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
monitoring one or more parameters of at least a first component of a compressed air system of a vehicle while a speed of a compressor motor of the compressed air system is modified over time, the one or more parameters monitored based on signals generated by one or more sensors; and
determining a condition of at least the first component of the compressed air system based on an analysis of the one or more parameters that are monitored.

2. The method of claim 1, further comprising:
establishing a communication link between a diagnostic kit and a vehicle control system disposed onboard the vehicle; and
receiving, at the diagnostic kit, a notification message from the vehicle control system, the notification message indicating a status of the speed of the compressor motor.

3. The method of claim 2, further comprising notifying the diagnostic kit prior to implementing a planned change in the speed of the compressor motor, and the notification message indicates a planned change in the speed of the compressor motor.

4. The method of claim 3, further comprising switching from monitoring the one or more parameters of the first component to monitoring one or more parameters of a second component of the compressed air system in response to receiving the notification message, and the second component is selected for monitoring based on the planned change in the speed of the compressor motor.

5. The method of claim 1, further comprising initiating a test sequence that includes changing the speed of the compressor motor over time.

6. The method of claim 5, wherein the test sequence is an outbound test that is performed to approve the vehicle for regular service, and the method includes approving the vehicle for regular service based at least in part on the condition of the first component as determined.

7. The method of claim 1, wherein the one or more parameters are monitored while the compressor motor is in an unloaded state.

8. The method of claim 1, wherein monitoring the one or more parameters comprises monitoring a first parameter of the first component of the compressed air system while the speed of the compressor motor is a first speed value or within a first speed range, and monitoring at least one of (i) a second parameter of the first component or (ii) the first parameter of a second component of the compressed air system while the speed of the compressor motor is a second speed value or within a second speed range.

9. The method of claim 1, wherein the one or more parameters are monitored by monitoring one or more actuation parameters of a first switch device and a second switch device that each controls power to the compressor motor, the one or more actuation parameters including one or more of time-to-close, time-to-open, extent of chatter, or contact resistance.

10. The method of claim 9, wherein monitoring the one or more actuation parameters comprises monitoring the one or more actuation parameters of the first switch device during a first time period in which the first switch device is actuated, and monitoring the one or more actuation parameters of the second switch device during a second time period in which the second switch device is actuated.

11. The method of claim 10, wherein the monitoring of the one or more actuation parameters of the second switch device is responsive to receiving a notification message from a vehicle control system disposed onboard the vehicle prior to the second time period, the notification message indicating that the second switch device will be actuated during the second time period.

12. The method of claim 1, further comprising determining a predicted remaining life of the first component of the compressed air system based on the condition that is determined.

13. The method of claim 1, wherein monitoring the one or more parameters comprises determining a charge parameter of a switch device of the compressed air system, and the method comprises:
receiving cycle data of the switch device; and
determining a predicted remaining life of the switch device based on both the charge parameter and the cycle data.

14. The method of claim 1, wherein in response to the condition of a first switch device of the compressed air system indicating that the first switch device is in a degraded state, the method comprises controlling the compressor motor to operate at one or more speeds that do not require closing the first switch device.

15. The method of claim 1, wherein in response to the condition of the first component of the compressed air system indicating that the first component is in a degraded state, the method comprises at least one of (i) operating the vehicle to consume less compressed air than if the first component was not in the degraded state or (ii) utilizing a different source of compressed air onboard the vehicle other than the compressed air system.

16. The method of claim 1, further comprising:
storing values of at least a first parameter of the one or more parameters over time as historical data;
analyzing the historical data to determine a trend in the first parameter; and
determine the condition of the first component based on the trend.

17. The method of claim 1, wherein the first component of the compressed air system is the compressor motor, and monitoring the one or more parameters of the first component comprises determining an eccentricity parameter of the compressor motor.

18. A monitoring system comprising:
one or more sensors; and
a controller having one or more processors that are configured to receive signals generated by the one or more sensors, the controller configured to use the signals to monitor one or more parameters of at least a first component of a compressed air system of a vehicle while a speed of a compressor motor of the compressed air system is modified over time, the controller configured to determine a condition of at least the first component of the compressed air system based on an analysis of the one or more parameters that are monitored.

19. The monitoring system of claim 18, wherein the one or more sensors are one or more removable sensors of a diagnostic kit that are removably coupled to the compressed air system, the diagnostic kit including the controller that monitors the one or more parameters.

20. The monitoring system of claim 18, further comprising a communication device configured to receive a notification message from a vehicle control system, the notification message indicating a planned change in the speed of the compressor motor prior to implementing the planned change in the speed of the compressor motor,
the controller configured to switch from monitoring the one or more parameters of the first component to monitoring one or more parameters of a second component of the compressed air system in response to receiving the notification message, wherein the second component is selected for monitoring based on the planned change in the speed of the compressor motor.
